(19) United States
(12) Patent Application Publication
(10) Pub. No.: US 2009/0201696 A1
(43) Pub. Date: Aug. 13, 2009

(54) LIGHT GUIDE BODY FOR LINEAR LIGHTING EQUIPMENT

(75) Inventors: Mitsuru KAMIKATANO, Sakura-shi (JP); Takashi Tsumanuma, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Tokyo (JP)

(21) Appl. No.: 12/359,834

(22) Filed: Jan. 26, 2009

(30) Foreign Application Priority Data
Jul. 26, 2006 (JP) 2006-202694

(51) Int. Cl. G02B 6/00

(52) U.S. Cl. 362/551

(57) ABSTRACT

A light guide body for linear lighting equipment is formed in a rod shape. A plurality of recessed portions are formed at the center of a first side face of the light guide body at intervals in the length direction of the light guide body, and each of the plurality of recessed portions is provided with a reflection scatter face which reflects and scatters light made incident onto the light guide body from a light source connected to one end of the light guide body and two wall faces separated from each other in the width direction of the light guide body. Further, each of the plurality of recessed portions exists between the two wall faces along the width direction of the light guide body.

### BACKGROUND OF THE INVENTION

1. Field of the Invention

The present invention relates to a light guide body used in linear lighting equipment in which an LED is mainly used as a light source.

2. Description of the Related Art

In recent years, LEDs (light emitting diodes) have found various uses as highly efficient long-life light sources. An LED is a directional point light source and often restricted from use as a spot illumination when used solely. When used as a linear light source, many LEDs may be arranged so as to form an array. However, in this instance, many LEDs are needed even under such use that will not require a great quantity of light and they must be mounted or wired, which contributes to higher costs.

On the other hand, LEDs have improved year by year in output performance, some of which are provided with a sufficient quantity of light even when used solely. There is a technology in which the above-described high output LEDs are combined with a light guide body to constitute linear lighting equipment (or a linear light source). This type of linear lighting equipment is linear lighting equipment 10′ which is shown in FIG. 12 to FIG. 14. A light guide body 1′ of the linear lighting equipment 10′ is formed in a rod shape so as to give a rectangular cross section. V-shaped grooves 3′ having a reflection scatter face 3a′ are arranged at intervals on a side face 1a′ on which the light guide body 1′ is placed so as to form an array in the length direction of the light guide body 1′. When light is made incident onto the light guide body 1′ from a light source 2 connected to one end face of the light guide body 1′ in the length direction, the reflection scatter faces 3a′ reflect and scatter the incident light toward the other side faces.

For example, Japanese Patent No. 2900799, Published Japanese Translation No. 2001-509307 of the PCT International Application, and Japanese Unexamined Patent Application, First Publication No. 2002-352603 disclose linear lighting equipment which is different in detailed structure but substantially similar in fundamental structure to the light guide body shown in FIG. 13 to FIG. 15. In addition to the above-described equipment, there is available linear lighting equipment 10″ shown in FIG. 16A and FIG. 16B. A light guide body 1″ of the linear lighting equipment 10″ is formed in a rod shape so as to give a circular cross section. V-shaped grooves 3″ formed along the width direction of the light guide body 1″ are arranged at intervals on a part of the peripheral face of the light guide body 1″ along the length direction so as to give an array in the length direction of the light guide body 1″.

In order to constitute a rod-shaped light guide body which can be utilized as the above-described linear lighting equipment (or the linear light source), as shown in FIG. 13 to FIG. 15, in addition to a method for forming V-shaped grooves on the light guide body, there is available a method for giving white printing to the side face of the rod-shaped light guide body, that for etching or sand-blasting the side face of the rod-shaped light guide body, and that for dispersing light scattering fine particles to the rod-shaped light guide body. However, in the rod-shaped light guide body constituted by adopting the above methods, light which is reflected and scattered is weak in directivity to result in a wide dispersion of the light.

Therefore, in an application which needs light with a strong directivity, a reflection plate, etc., must be used. Therefore, the present invention is to deal with a light guide body which is fundamentally structured as shown in FIG. 13 to FIG. 15.

In the linear lighting equipment shown in FIG. 13 to FIG. 15, the groove 3′ of the light guide body 1′ is in general a V shape in cross section, and the groove 3′ is formed so as to cross the light guide body 1′ over the entire width direction of the light guide body 1′. In other words, the bottom 3b′ of the V-shaped groove 3′ is formed in a straight line and extends up to the side faces 1c′ respectively arranged on both sides of a side face on which the groove 3′ is formed. Therefore, when stress such as bending is applied to the light guide body 1′, the light guide body 1′ will be easily broken, with the bottom 3b′ acting as a starting point for the stress. In the linear lighting equipment 10″ shown in FIG. 16A and FIG. 16B as well, the bottom 3b″ of the groove 3″ is formed in a straight line and extends up to the circular face of the light guide body 1″.

In the above-described light guide body on which the V-shaped grooves are formed, in order to make the light guide body look as if it would emit light continuously in the length direction, it is necessary to decrease the interval (pitch) between these grooves and also make each of the grooves shallow. When the pitch between the grooves is decreased, as a matter of course, the total number of the grooves is increased. Thus, on the assumption that the quantity of incident light is constant, it is necessary to reduce the quantity of light reflected and scattered per groove. In other words, since the quantity of light reflected and scattered for each groove is fundamentally proportional to the cross-sectional area of the groove (length of the groove along the groove direction of the light guide body W×depth of the groove H), the depth of the groove H must be made shallow, if the length of the groove W is constant.

However, it is not easy to secure a high machining accuracy (accuracy) in machining a very shallow groove. Further, when the pitch between shallow grooves is extremely short, a variation in depth of the grooves is found, which will easily result in a variation in the quantity of light (brightness) reflected on the grooves. As a result, there is naturally a limit to a short pitch between the grooves.

Further, in the linear lighting equipment shown in FIG. 13 to FIG. 15, light made incident from the light source 2 into the light guide body 1′ and reaching up to a reflection scatter face 3a′ of each groove 3′ is mostly reflected perpendicular to incident light as given by the arrow P₁ and output from the side face 1b′ opposite to a side face 1a′ on which the groove 3′ is formed.

On the other hand, light made incident onto the reflection scatter face 3a′ at an angle exceeding a total reflection critical angle as given by the arrow P₂ passes through the reflection scatter face 3a′. Some of the light which has passed through the reflection scatter face 3a′ is again made incident onto the light guide body 1′ from another face 3c′ opposing the reflection scatter face 3a′ of the groove 3′, while the remaining light proceeds to an opening of the groove 3′ as given by the arrow P₃ or proceeds to the side faces 1c′ of the light guide body 1′ as given in the arrow P₄. The light proceeding to the opening of the groove 3′ or the side faces 1c′ of the light guide body 1′ results in leakage outside the light guide body 1′, thus contributing to reduction in use efficiency of light.

The present invention has been made in view of the above situation, objects of which are that a light guide body is improved in breaking strength against bending, that where a pitch between the grooves is decreased to make a light guide body look as if it would emit light continuously in the length direction, it is made less likely to cause a variation in the quantity of light (brightness) reflected on the grooves and that the use efficiency of light is prevented from being further reduced.

### SUMMARY OF THE INVENTION

The light guide body for the linear lighting equipment in the present invention is formed in a rod shape. A plurality of recessed portions are formed at intervals on a first side face of the light guide body in the length direction of the light guide body. Each of the plurality of recessed portions is provided with a reflection scatter face which reflects and scatters light made incident onto the light guide body from a light source connected to one end of the light guide body and two wall faces separated from each other in the width direction of the light guide body. Further, each of the plurality of recessed portions exists between two wall faces along the width direction.

In the light guide body of the present invention, the recessed portion may be formed in a V shape, the cross section of which is parallel with the length direction of the light guide body and perpendicular to the first side face.

In the light guide body of the present invention, two second side faces existing on both sides of the first side face may be inclined to the first side face respectively at a predetermined angle. The predetermined angle may be not less than 30 degrees and not more than 60 degrees.

In the light guide body of the present invention, the two second side faces existing on both sides of the first side face may be curved respectively so as to project outward.

In the light guide body of the present invention, the first side face may be recessed with respect to the two second side faces existing on both sides of the first side face.

In the light guide body of the present invention, a raised portion including another face of the recessed portion opposing the reflection scatter face is formed on the first side face, and the cross section of the raised portion parallel with the length direction of the light guide body and also perpendicular to the first side face may be formed approximately in a triangular shape or a trapezoidal shape.

In the light guide body of the present invention, the recessed portions may be arranged in plural arrays on the first side face.

According to the light guide body of the present invention, a plurality of recessed portions are formed at intervals on the first side face of the light guide body formed in a rod shape along the length direction of the light guide body, and each of the plurality of recessed portions is provided with a reflection scatter face which reflects and scatters light made incident onto the light guide body from a light source connected to one end of the light guide body and two wall faces separated from each other in the width direction of the light guide body. Further, each of the plurality of recessed portions exists between the two wall faces along the width direction. In other words, the bottom of the recessed portion only exists inside the light guide body and does not extend up to the side faces separated from each other in the width direction of the light guide body. Therefore, even upon application of bending stress to the light guide body, it is less likely that the bottom of the recessed portion will act as a starting point for breakage. Thus, as compared with the case where the bottom of the recessed portion extends up to the side faces of the light guide body, the light guide body can be improved in breaking strength against bending.

Further, unlike the groove of a conventional light guide body, the recessed portion does not cross the light guide body over the entire width direction of the light guide body, by which there is no restriction that the length of the recessed portions along the width direction of the light guide body is made constant. As a result, it is possible to shorten the length of the recessed portions along the width direction of the light guide body. Where the pitch between the recessed portions is decreased to make the light guide body look as if it would emit light continuously in the length direction, the length of the recessed portions along the width direction of the light guide body is made short. Thereby, it is possible to reduce the quantity of light reflected and scattered per recessed portion even if the recessed portions are not made shallow.

In addition, as described above, when the length of the recessed portions along the width direction of the light guide body is made short, the quantity of light reflected and scattered per recessed portion is reduced, although the recessed portions are not made excessively shallow. Therefore, as compared with a conventional light guide body on which shallow grooves are formed, it is made less likely to cause a variation in the quantity of reflected light (brightness) resulting from a variation in depth of the recessed portions.

Light which is made incident onto the reflection scatter face of the recessed portion at an angle exceeding a total reflection critical angle passes through a reflection scatter face. Light which proceeds to the side faces of the recessed portion after passage through the reflection scatter face will not result in leakage outside the light guide body but is reflected and scattered on wall faces of the recessed portion and again made incident onto the light guide body. Therefore, the quantity of light which leaks outside the light guide body will be small. It is, thus, possible to improve the use efficiency of light.

According to the light guide body of the present invention, two second side faces existing on both sides of the first side face are inclined to the first side face respectively at a predetermined angle. Therefore, as described above, light which proceeds to the second side faces after passage through the reflection scatter face is reflected on the second side faces to the inside of the light guide body after passage through the wall face of the recessed portion. Thereby, the quantity of light which leaks outside the light guide body is further reduced. Therefore, it is possible to further improve the use efficiency of light.

The inclined angle of the second side face to the first side face is preferably equal to or more than 30 degrees and is equal to or less than 60 degrees, and is more preferably, equal to or more than 40 degrees and is equal to or less than 50 degrees.

According to the light guide body of the present invention, two second side faces existing on both sides of the first side face are curved respectively so as to project outside. Therefore, as with the above description, light which proceeds to the second side faces after passage through the reflection scatter face passes through the wall face of the recessed portion and is again made incident onto the light guide body, and thereafter, the light is reflected on the second side faces to the inside of the light guide body. Therefore, the quantity of light which leaks outside the light guide body is further reduced. As a result, it is possible to further improve the use efficiency of light.

According to the light guide body of the present invention, since the first side face is recessed with respect to two second side faces existing on both sides of the first side face, some of the light which proceeds to an opening of the recessed portion is reflected on the second side faces to the inside of the light guide body after again being made incident onto the light guide body. Therefore, the quantity of light which leaks outside the light guide body is further reduced. As a result, it is possible to further improve the use efficiency of light.

According to the light guide body of the present invention, there is formed on the first side face a raised portion including another face of the recessed portion opposing the reflection scatter face. Further, the cross section of the raised portion parallel with the length direction of the light guide body and also perpendicular to the first side face is formed approximately in a triangular shape or a trapezoidal shape. Therefore, some of the light which proceeds from the recessed portion to the back (direction opposite to the light source) is again made incident onto the light guide body and thereafter reflected on a face forming the raised portion toward the inside of the light guide body. Thus, the quantity of light which leaks outside the light guide body is further reduced. As a result, it is possible to further improve the use efficiency of light.

According to the light guide body of the present invention, since the recessed portions are arranged in plural arrays on the first side face, the bottoms of the recessed portions having a V-shaped cross section are made short, which can act as a starting point for breakage, and the bottoms are also dispersed inside the light guide body. Therefore, the light guide body can be improved in breaking strength against bending.

### BRIEF DESCRIPTION OF THE DRAWINGS

FIG. 1 is a perspective view showing a first embodiment of the light guide body for linear lighting equipment of the present invention.

FIG. 2 is an enlarged view showing major parts of the light guide body given in FIG. 1.

FIG. 3A is a plan view showing a side face on which recessed portions of the light guide body given in FIG. 1 are arranged, FIG. 3B is a sectional view taken along line I to I given in FIG. 3A, and FIG. 3C is a sectional view taken along line II to II given in FIG. 3B.

FIG. 4 is a sectional view showing a second embodiment of a light guide body for linear lighting equipment of the present invention.

FIG. 5 is a sectional view showing a third embodiment of a light guide body for linear lighting equipment of the present invention.

FIG. 6 is a sectional view showing a fourth embodiment of a light guide body for linear lighting equipment of the present invention.

FIG. 7A is a sectional view showing a fifth embodiment of a light guide body for linear lighting equipment of the present invention, and FIG. 7B is a sectional view taken along line III to III given in FIG. 7A.

FIG. 8 is a sectional view showing a sixth embodiment of a light guide body for linear lighting equipment of the present invention.

FIG. 9A is a drawing showing a seventh embodiment of a light guide body for linear lighting equipment of the present invention, which is a plan view of a side face of the light guide body on which the recessed portions are arranged in two arrays. FIG. 9B is a sectional view taken along line IV to IV given in FIG. 9A.

FIG. 10A is a drawing showing a modified embodiment of the seventh embodiment of the light guide body for linear lighting equipment of the present invention, which is a plan view of a side face of the light guide body on which recessed portions are arranged in three arrays. FIG. 10B is a sectional view taken along line V to V given in FIG. 1A.

FIG. 11A is a drawing showing an eighth embodiment of a light guide body for linear lighting equipment of the present invention, which is a plan view of a side face of the light guide body on which the recessed portions are arranged in two arrays.

FIG. 11B is a sectional view taken along line VI to VI given in FIG. 11A.

FIG. 12A is a perspective view showing a ninth embodiment of a light guide body for linear lighting equipment of the present invention, and FIG. 12B is a sectional view showing major parts of the light guide body given in FIG. 12A.

FIG. 13 is a perspective view showing the light guide body of conventional linear lighting equipment.

FIG. 14 is a sectional view showing major parts of the light guide body given in FIG. 13.

FIG. 15 is a sectional view taken along line VII to VII given in FIG. 14.

FIG. 16A is a perspective view showing the light guide body of conventional linear lighting equipment, and FIG. 16B is a sectional view showing major parts of the light guide body given in FIG. 16A.

### DETAILED DESCRIPTION OF THE PREFERRED EMBODIMENTS

Hereinafter, a description will be given of the light guide body for linear lighting equipment of the present invention by referring to the drawings.

### First Embodiment

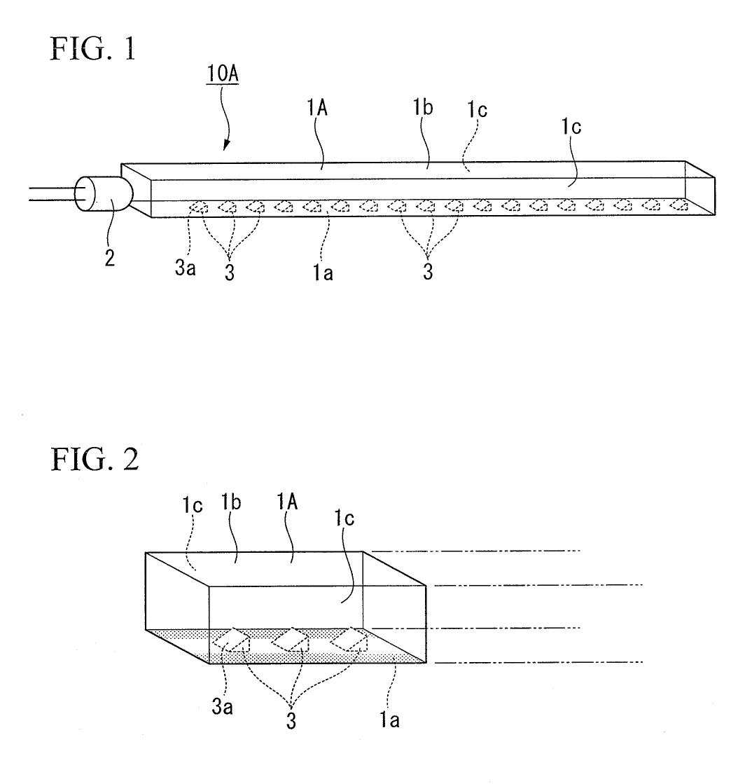

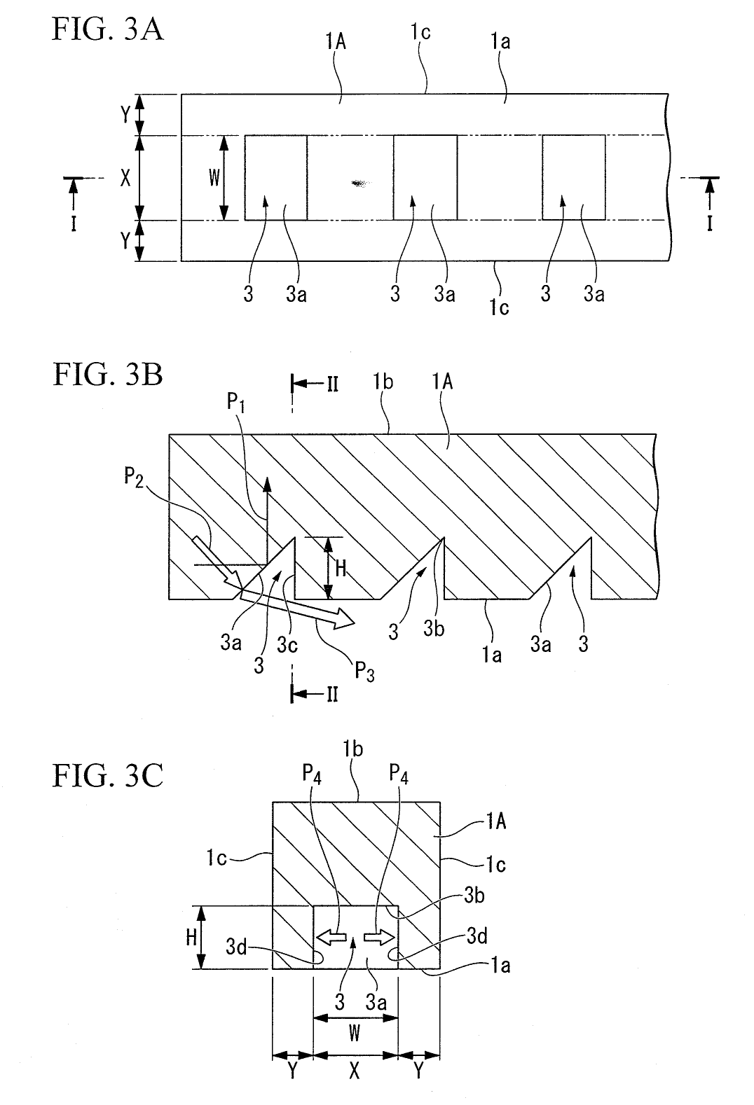

The first embodiment of the light guide body of the present invention is shown in FIG. 1 to FIG. 3C.

A light guide body 1A which constitutes linear lighting equipment 10A is made of acrylic resin, for example, and formed in a rod shape with a rectangular cross section. Recessed portions 3 having reflection scatter faces 3a and two wall faces 3d separated from each other in the width direction of the light guide body 1A are arranged at intervals on a side face 1a (first side face) of the light guide body 1A so as to give an array along the length direction of the light guide body 1A. When light is made incident onto the light guide body 1A from a light source 2 connected to one end face of the light guide body 1A in the length direction, the reflection scatter face 3a will reflect and scatter the incident light toward another side face.

Each of the plurality of recessed portions 3 exists between two wall faces 3d along the width direction of the light guide body 1A. In other words, the recessed portion 3 is formed at a band-like region X existing at the center of the side face 1a of the light guide body 1A along the length direction of the light guide body 1A so as not to extend to band-like regions Y existing on both sides of the region X. In the present embodiment, the plurality of the recessed portions 3 are arranged in one array.

The recessed portion 3 may be adopted as a groove having a V-shaped cross section which is parallel with the length direction of the light guide body 1A and also perpendicular to the side face 1a. Hereinafter, a description will be given of the case where the recessed portion 3 having a V-shaped cross section is adopted.

In the above-described light guide body 1A, the bottom 3b of the recessed portion 3 only exists inside the light guide body 1A and does not extend up to the side faces (second side faces) 1c separated from each other in the width direction of the light guide body 1A. Therefore, even when bending stress is applied to the light guide body 1A, it is less likely that the bottom 3b of the recessed portion 3 will act as a starting point for breakage. Thus, as compared with the case where the bottom 3b of the recessed portion 3 extends up to the side faces 1c of the light guide body 1A, the light guide body 1A is improved in breaking strength against bending.

Further, unlike the groove of a conventional light guide body, since the recessed portion 3 does not cross the light guide body 1A over the entire width direction of the light guide body 1A, the length of the recessed portions 3 is not restricted from being constant along the width direction of the light guide body 1A. Therefore, it is possible to make short the length of the recessed portions 3 along the width direction of the light guide body 1A. Where the pitch between the recessed portions 3 is decreased to make the light guide body 1A to look as if it would emit light continuously in the length direction, the recessed portions 3 are made shorter in length along the width direction of the light guide body 1A. Thereby, it is possible to reduce the quantity of light reflected and scattered per recessed portion 3, although the recessed portions 3 are not made shallow.

In addition, if the length of the recessed portions 3 is made short along the width direction of the light guide body 1A as described above, the quantity of light reflected and scattered per recessed portion 3 is reduced, although the recessed portions 3 are not made excessively shallow. According to the light guide body 1A on which the recessed portions 3 are made deep, as compared with a conventional light guide body on which the grooves are made shallow, it is made less likely to cause a variation in quantity of reflected light (brightness) resulting from a variation in depth of recessed portions. In other words, on the assumption that machining accuracy (variation in dimensional difference) of the recessed portions is substantially the same irrespective of whether the recessed portions are shallow or deep, the proportion (not a dimensional difference but a percentage) of variation in depth of individual recessed portions on a light guide body where deep recessed portions are formed is smaller than the proportion of variation in depth of individual recessed portions on a light guide body where shallow recessed portions are formed.

In this instance, consideration will be made only for the accuracy of depth H at the recessed portions 3 and will not be made for the accuracy of length W of the recessed portions 3 along the width direction of the light guide body 1A. However, in the rod-shaped light guide body which is dealt with by the present invention, since the depth H of the recessed portions is in most cases smaller than the length W of the recessed portions, there is hardly posed a problem on the accuracy of the length W of the recessed portions.

In the above-described linear lighting equipment 10A, light which is made incident onto the light guide body 1A from the light source 2 and reaches up to the reflection scatter face 3a of each of the recessed portions 3 is mostly reflected perpendicular to incident light as shown by the arrow P₁ and output from a side face 1b opposite to the side face 1a on which the recessed portions 3 are formed. The side face 1b emits illumination light uniform in brightness in the length direction of the light guide body 1A.

On the other hand, light which is made incident onto the reflection scatter face 3a at an angle exceeding a total reflection critical angle as shown by the arrow P₂ passes through the reflection scatter face 3a. Some of the light which has passed through the reflection scatter face 3a is again made incident onto the light guide body 1A from another face 3c opposing the reflection scatter face 3a of the recessed portion 3, while the remaining light proceeds to an opening of the recessed portion 3, as shown by the arrow P₃, or proceeds to the side faces 1c of the light guide body 1A, as shown by the arrow P₄. Light proceeding to the opening of the recessed portion 3 will leak outside the light guide body 1A. Light proceeding to the side faces 1c of the light guide body 1A will not leak outside the light guide body 1A, unlike a conventional groove 3′ which crosses a light guide body 1′ over the entire width direction thereof as shown in FIG. 14. Some of the light is reflected and scattered on the wall face 3d of the recessed portion 3 and again made incident onto the light guide body 1A. Therefore, the quantity of light which leaks outside the light guide body 1A will be small. It is, thereby, possible to improve the use efficiency of light.

### Second Embodiment

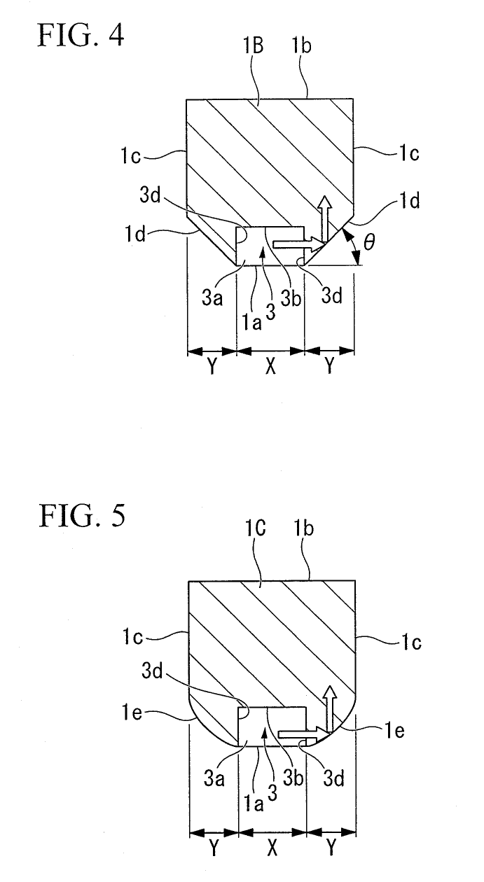

FIG. 4 shows a second embodiment of the light guide body of the present invention.

In the light guide body 1B of the present embodiment, two side faces 1d (second side faces) existing on both sides of a side face (first side face) 1a of the light guide body 1B are respectively inclined to the side face 1a at a predetermined angle. In other words, the side faces 1d corresponding to regions Y up to which a bottom 3b of the recessed portion 3 does not extend are inclined at a predetermined angle to the side face 1a corresponding to a region X at which the recessed portion 3 is formed. As described above, when the side faces 1d corresponding to the regions Y are inclined to the side face 1a corresponding to the region X, light which proceeds to the side faces 1d after passage through the reflection scatter face 3a passes through a wall face 3d of the recessed portion 3 and is again made incident onto the light guide body 1B and thereafter reflected on the side faces 1d toward the side face 1b. Therefore, the quantity of light which leaks outside the light guide body 1B is further reduced. It is, thereby, possible to further improve the use efficiency of light.

In order to reflect light toward the side face 1b, an inclined angle θ of the side face 1d with respect to the side face 1a is preferably equal to or more than 30 degrees and is equal to or less than 60 degrees, and is more preferably, n equal to or more than 40 degrees and is equal to or less than 50 degrees.

### Third Embodiment

FIG. 5 shows a third embodiment of the light guide body of the present invention.

In the light guide body 1C of the present embodiment, two side faces (second side faces) 1e existing on both sides of the side face (first side face) 1a of the light guide body 1C are curved so as to project outward. In other words, the side faces 1e corresponding to regions Y up to which the bottom 3b of the recessed portion 3 does not extend are curved so as to project outward.

As described above, the side faces 1e corresponding to the regions Y are curved, by which, as with the above-described second embodiment, light which proceeds to the side faces 1e after passage through the reflection scatter face 3a passes through the wall face 3d of the recessed portion 3 and is again made incident onto the light guide body 1C and thereafter is reflected on the side faces 1e toward the side face 1b. Therefore, the quantity of light which leaks outside the light guide body 1C is further reduced. It is, thereby, possible to further improve the use efficiency of light.

### Fourth Embodiment

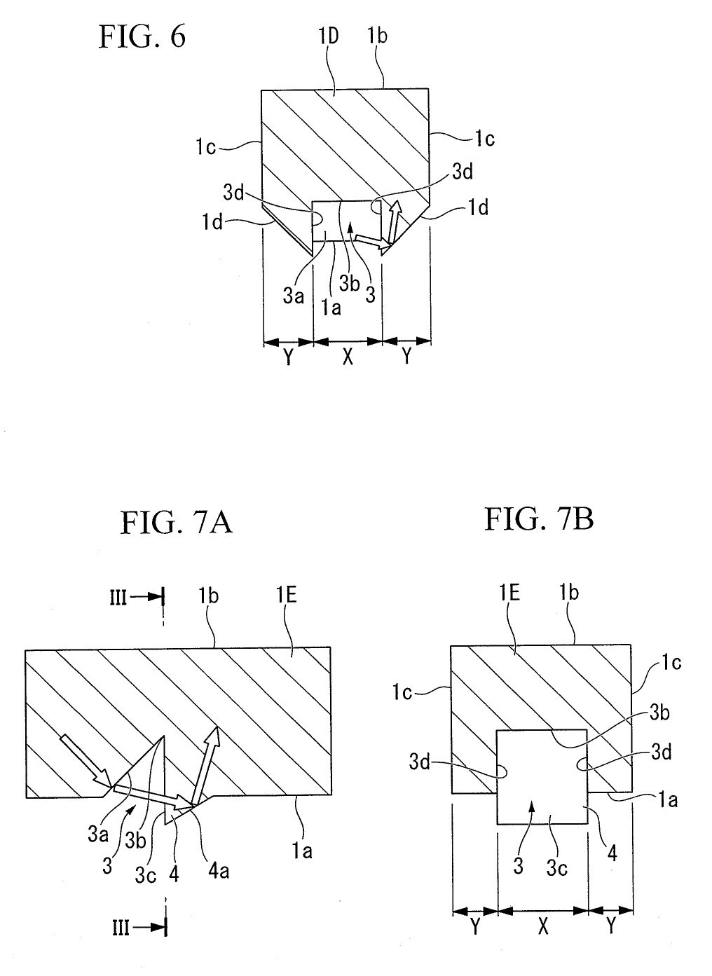

FIG. 6 shows a fourth embodiment of the light guide body of the present invention.

In the light guide body 1D of the present embodiment, a side face (first side face) 1a of the light guide body 1D is recessed with respect to two side faces (second side faces) 1d on both sides of the side face 1a. In other words, the side face 1a corresponding to a region X at which the recessed portion 3 is formed is recessed with respect to the side faces 1d corresponding to regions Y up to which the bottom 3b of the recessed portion 3 does not extend. As with the second embodiment, the side faces 1d are inclined at a predetermined angle with respect to the side face 1a. The side face 1a is recessed toward the inside of the light guide body 1D from ridge lines at which the side faces 1d are in contact with the wall faces 3d of the recessed portion 3.

As described above, when the side face 1a corresponding to the region X is recessed with respect to the side faces 1d corresponding to the regions Y, some of the light which proceeds to an opening of the recessed portion 3 is also reflected on the side faces 1d toward the side face 1b after again being made incident onto the light guide body 1D. Therefore, the quantity of light which leaks outside the light guide body is further reduced. It is, thereby, possible to further improve the use efficiency of light.

### Fifth Embodiment

FIG. 7A and FIG. 7B show a fifth embodiment of the light guide body of the present invention.

In the light guide body 1E of the present embodiment, a plurality of raised portions 4 are provided on a side face (first side face) 1a of the light guide body 1E so as to correspond to each of the plurality of recessed portions 3. Each of the raised portions 4 includes another face 3c opposing a reflection scatter face 3a of the recessed portion 3 and projects from the side face 1a. In other words, the raised portion 4 including another face 3c opposing the reflection scatter face 3a of the recessed portion 3 is formed on the side face 1a corresponding to a region X at which the recessed portion 3 is formed. The cross section of the raised portion 4 parallel with the length direction of the light guide body 1E and also perpendicular to the side face 1a is formed approximately in a triangular shape.

Each of the recessed portions 3 exists between two wall faces 3d along the width direction of the light guide body 1E. In other words, the recessed portion 3 is formed at a band-like region X existing at the center of the side face 1a of the light guide body 1A along the length direction of the light guide body 1E so as not to extend up to band-like regions Y existing on both sides of the region X.

As described above, when the raised portion 4 having an approximately triangular cross section is provided on the side face 1a of the light guide body 1E, some of the light which proceeds from the recessed portion 3 backward (direction opposite to the light source 2) is again made incident onto the light guide body 1E and thereafter reflected on a face 4a forming the raised portion 4 toward the side face 1b. Therefore, the quantity of light which leaks outside the light guide body 1E is further reduced. It is, thereby, possible to further improve the use efficiency of light.

### Sixth Embodiment

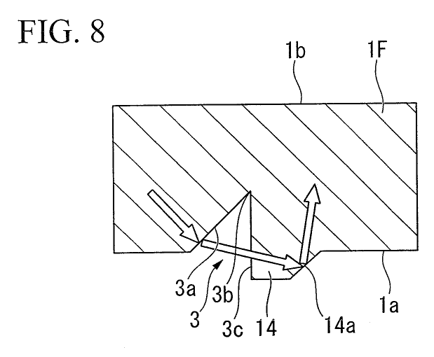

FIG. 8 shows a sixth embodiment of the light guide body of the present invention.

In the light guide body 1F of the present embodiment, a plurality of raised portions 14 are formed on a side face (first side face) 1a of the light guide body 1F so as to correspond to each of the plurality of recessed portions 3. Each of the raised portions 4 includes another face 3c opposing a reflection scatter face 3a of the recessed portion 3 and projects from the side face 1a. The cross section of the raised portion 14 is formed in a trapezoidal shape. Although not illustrated, as with the above-described sixth embodiment, each of the recessed portions 3 exists between two wall faces along the width direction of the light guide body 1F.

As so far described, when the raised portion 14 having a trapezoidal cross section is provided on the side face 1a of the light guide body 1F, some of the light which proceeds from the recessed portion 3 backward is again made incident onto the light guide body 1F and thereafter reflected on a face 14a which forms the raised portion 14 toward the side face 1b. Therefore, the quantity of light which leaks outside the light guide body 1F is further reduced. It is, thereby, possible to further improve the use efficiency of light.

### Seventh Embodiment

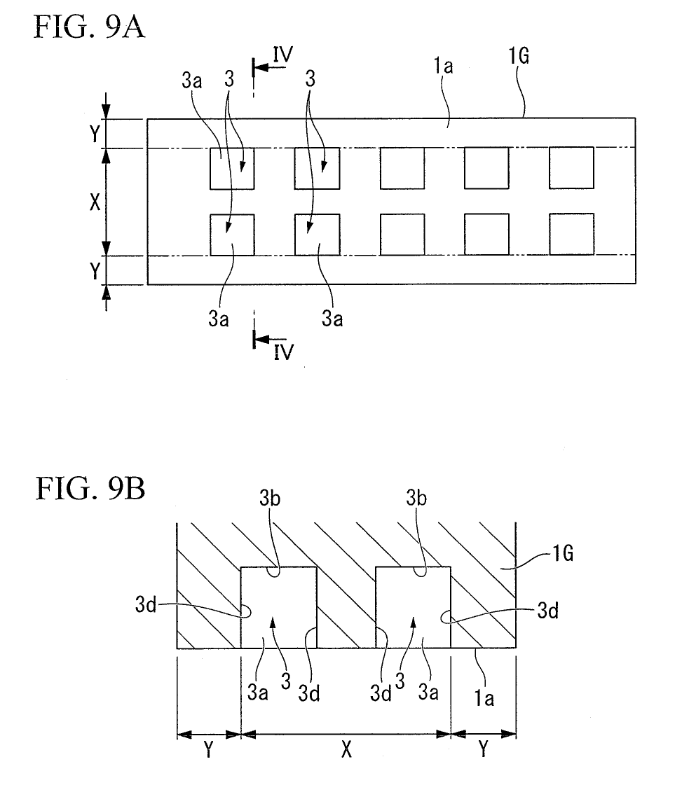

FIG. 9A and FIG. 9B show a seventh embodiment of the light guide body of the present invention.

In the present embodiment, recessed portions 3 are arranged on a side face 1a corresponding to a region X of a light guide body 1G so as to give two arrays. The recessed portions 3 belonging to either of these arrays exist between two wall faces 3d along the width direction of the light guide body 1G.

As described above, when the recessed portions 3 are arranged on the side face 1a so as to give two arrays, as compared with the case where the recessed portions 3 are arranged so as to give one array, bottoms 3b of the V-shaped recessed portions 3 are made short, which can act as a starting point for breakage, and the bottoms 3b are also dispersed inside the light guide body 1G. Therefore, the breaking strength against bending is further improved.

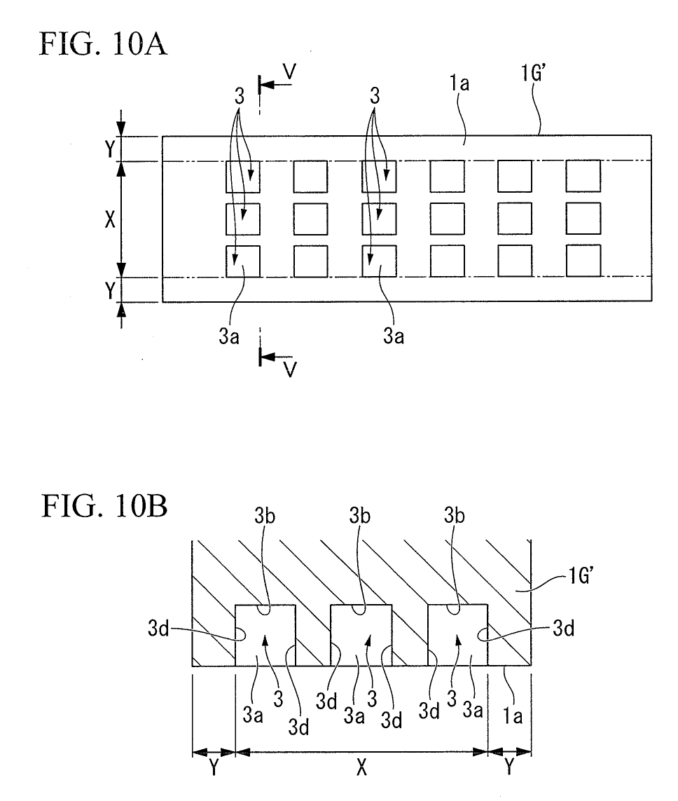

FIG. 10A and FIG. 10B show a modified example of the seventh embodiment.

In this modified example, recessed portions 3 are arranged on a side face 1a corresponding to a region X of a light guide body 1G′ so as to give three arrays. As described above, when the recessed portions 3 are arranged on the side face 1a so as to give three arrays, as compared with the seventh embodiment, bottoms 3b of the V-shaped recessed portion 3 are made short, which can act as a starting point for breakage, and the bottoms 3b are also dispersed inside the light guide body 1G′. Thus, the breaking strength against bending is further improved.

### Eighth Embodiment

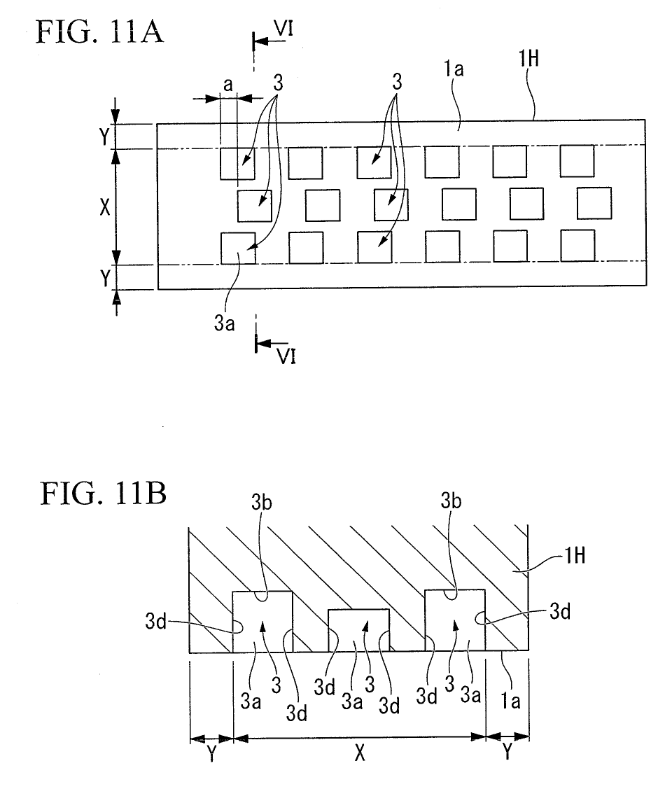

FIG. 11A and FIG. 11B show an eighth embodiment of the light guide body of the present invention.

In the present embodiment, as with the modified example of the seventh embodiment, recessed portions 3 are arranged on a side face 1a corresponding to a region X of a light guide body 1H so as to give three arrays. Then, the recessed portions 3 forming one array at the center are arranged so as to be deviated with respect to the recessed portions 3 forming the arrays on both sides in the length direction of the light guide body 1H (deviated amount is expressed by a). As described above, when a certain array is arranged so as to be deviated with respect to other arrays, bottoms 3b of the recessed portions 3 having a V-shaped cross section are dispersed in the length direction of the light guide body 1H. Therefore, it is less likely that the bottom 3b of the recessed portion 3 acts as a starting point for breakage, and the breaking strength against bending is further improved. It is noted that in place of the present embodiment in which only one array is arranged so as to be deviated from the other arrays, all the arrays may be arranged so as to be deviated from each other.

### Ninth Embodiment

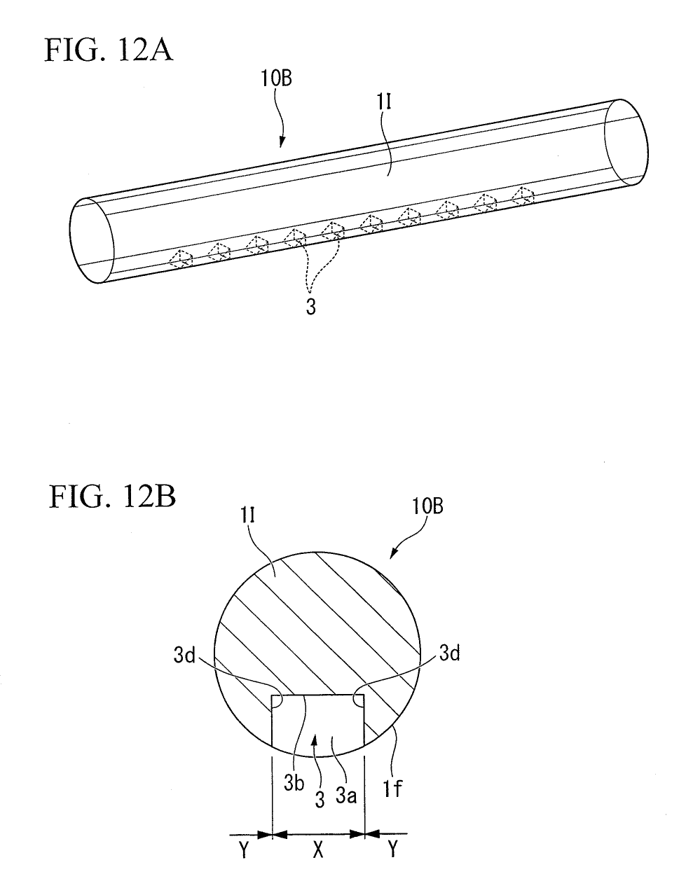

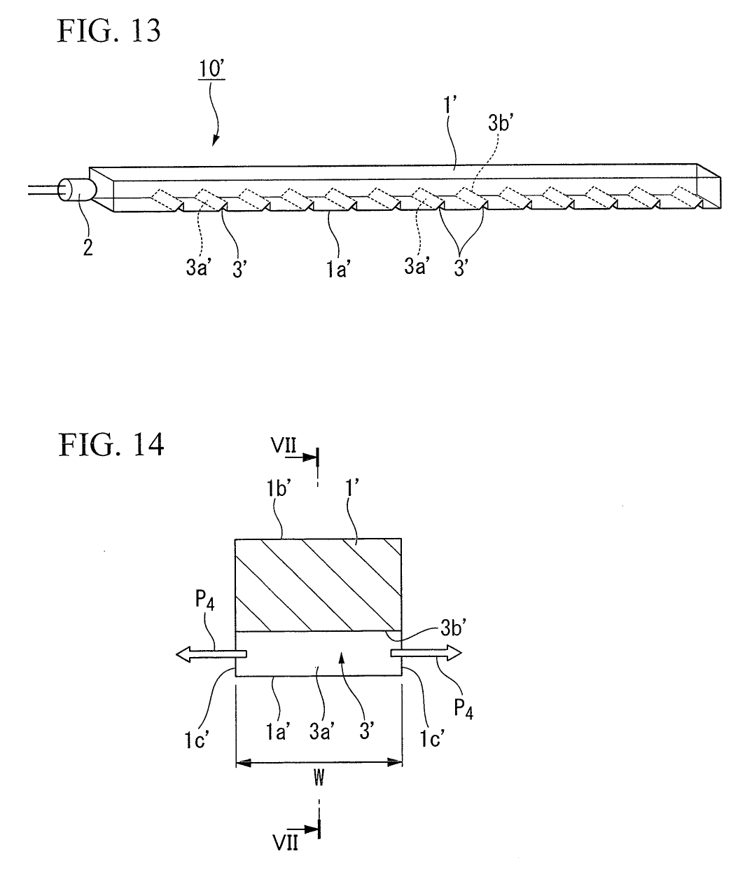

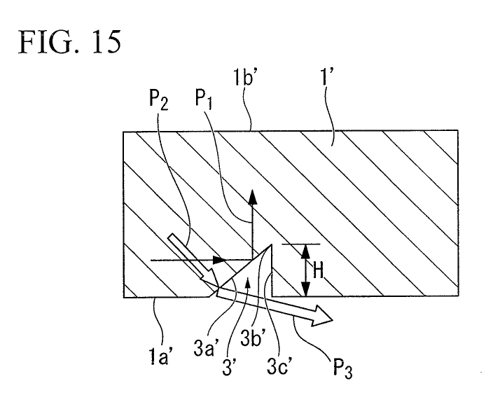

FIG. 12A and FIG. 12B show a ninth embodiment of the light guide body of the present invention.

In the present embodiment, a light guide body 1I which constitutes linear lighting equipment 10B is formed so as to give a circular rod shape in its cross section. A plurality of recessed portions 3 individually exists between two wall faces 3d along the width direction of the light guide body 1I. In other words, they are formed in a band-like region X existing at a part of a peripheral face (second side face) 1f of the light guide body 1I along the length direction of the light guide body 1I so as not to extend up to regions Y excluding the region X.

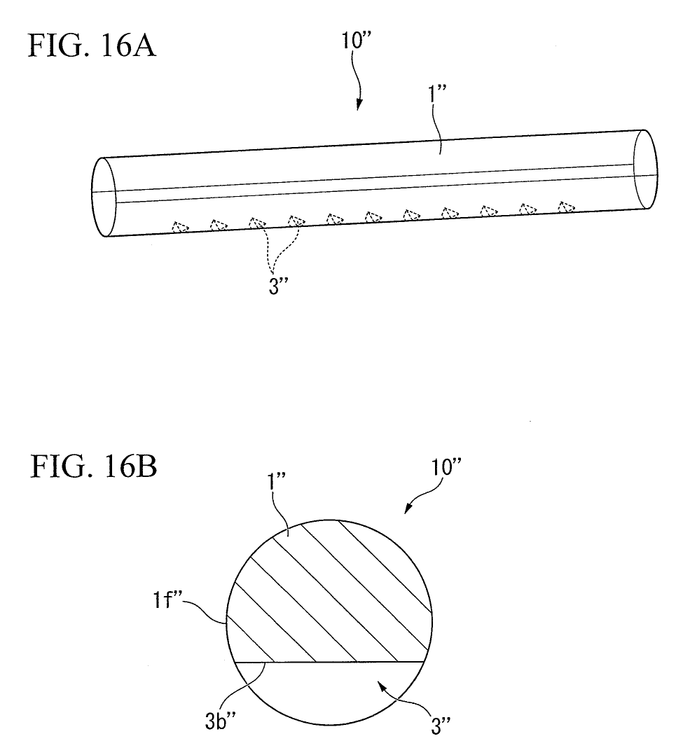

The bottom 3b of the recessed portion 3 exists only inside the light guide body 1I and does not extend up to the peripheral face 1f corresponding to the regions Y. Therefore, even if bending stress is applied to the light guide body 1, it is less likely that the bottom 3b of the recessed portion 3 acts as a starting point for breakage. Thus, as compared with the case where a bottom 3b″ of a recessed portion 3″ extends up to a peripheral face 1f″ of a light guide body 1″ as shown in FIG. 16B, the light guide body 1I is improved in breaking strength against bending. In addition, the same effects as those of the first embodiment are also obtained.

A description has been so far given of preferred embodiments of the present invention, to which the present invention shall not be, however, restricted. The present invention may be subjected to addition of the constitution, omission, replacement and other modifications within a scope not departing from the gist of the present invention. The present invention shall not be restricted to the above description but is restricted only by the scope of the attached claims.

For example, the cross section of the recessed portion of the present invention shall not be restricted to a V shape but may include various shapes.

What is claimed is:

1. A light guide body for linear lighting equipment, wherein
the light guide body is formed in a rod shape,
a plurality of recessed portions are formed on a first side face of the light guide body at intervals in a length direction of the light guide body,
each of the plurality of recessed portions is provided with a reflection scatter face which reflects and scatters light made incident onto the light guide body from a light source connected to one end of the light guide body and two wall faces separated from each other in a width direction of the light guide body, and
the recessed portion exists between the two wall faces along the width direction.

2. The light guide body for linear lighting equipment according to claim 1, wherein
the recessed portion has a V-shaped cross section which is parallel with the length direction of the light guide body and also perpendicular to the first side face.

3. The light guide body for linear lighting equipment according to claim 1, wherein
two second side faces existing on both sides of the first side face are inclined to the first side face respectively at a predetermined angle.

4. The light guide body for linear lighting equipment according to claim 3, wherein
the predetermined angle is equal to or more than 30 degrees and is equal to or less than 60 degrees.

5. The light guide body for linear lighting equipment according to claim 1, wherein
the two second side faces existing on both sides of the first side face are curved so as to project outward.

6. The light guide body for linear lighting equipment according to claim 1, wherein
the first side face is recessed with respect to the two second side faces existing on both sides of the first side face.

7. The light guide body for linear lighting equipment according to claim 1, wherein
a raised portion including another face of the recessed portion opposing the reflection scatter face is formed on the first side face, and
a cross section of the raised portion which is parallel with the length direction of the light guide body and also perpendicular to the first side face is formed approximately in a triangular shape or a trapezoidal shape.

8. The light guide body for linear lighting equipment according to claim 1, wherein
the recessed portions are arranged on the first side face so as to give plural arrays.
